(19) United States
(12) Patent Application Publication
(10) Pub. No.: US 2014/0296999 A1
(43) Pub. Date: Oct. 2, 2014

(54) SENSOR NODE AND RELIABLE METHOD FOR TRACKING BOUNDARY OF CONTINUOUS OBJECTS USING ASSISTANCE NODE IN WIRELESS SENSOR NETWORK

(71) Applicant: Electronics and Telecommunications Research Institute, Daejeon (KR)

(72) Inventors: Sang-Wan KIM, Daejeon (KR); Joon-Kyung LEE, Daejeon (KR); Dong-Won KANG, Daejeon (KR)

(73) Assignee: Electronics and Telecommunications Research Institute, Daejeon (KR)

(21) Appl. No.: 14/179,523

(22) Filed: Feb. 12, 2014

(30) Foreign Application Priority Data
Mar. 27, 2013 (KR) 10-2013-0032992

(51) Int. Cl. H04W 24/04; H04W 84/18; H04W 52/02; G05B 15/02

(52) U.S. Cl. CPC H04W 24/04; G05B 15/02; H04W 84/18; H04W 52/0251
USPC 700/12; 370/221

(57) ABSTRACT

A method for tracking a boundary of continuous objects, capable of ensuring reliability by additionally selecting an assistance node, the method including a boundary information reception operation dividing sensor nodes, according to a plurality of predetermined areas to select representative nodes each representing sensor nodes, and receiving boundary information including event sensing information from the representative nodes that collect the boundary information from the sensor nodes, a representative node information reception operation selecting one or more assistance nodes configured to collect representative node information from the selected representative nodes, and receiving the representative node information from the assistance nodes that receive the representative node information, as well as a continuous object boundary implementing operation implementing a boundary of continuous objects by combining the boundary information or the representative node information that is received from the respective representative nodes and the respective assistance nodes.

### CROSS-REFERENCE TO RELATED APPLICATION

This application claims the benefit under 35 U.S.C. §119(a) of Korean Patent Application No. 10-2013-0032992, filed on Mar. 27, 2013, the entire disclosure of which is incorporated herein by reference for all purposes.

### BACKGROUND

1. Field

The following description relates to technology for a sensor network, and more particularly, to technology for a method for tracking a boundary of continuous objects in a wireless sensor network.

2. Description of the Related Art

A wireless sensor network represents a small sized wireless transmission/reception apparatus network system in which information collected through a sensor is processed using a processor, and transmitted. The development of the wireless sensor network was initiated for military use, but currently is being used in various applications, for example, remote site monitoring of animals in their ecosystems, a maintenance apparatus for soil humidity using a humidity sensor, monitoring of urban infrastructures, such as roads and buildings, and personal health monitoring.

In particular, in addition to military purposes, the wireless sensor network is used in civilian-use applications, such as in wildfire detection, to detect moving objects and to track the path of action of the moving object. The tracking of a path of the moving object is broadly divided into two types depending on the characteristic of the moving object. One type is an individual object tracking for tracking an object significantly smaller in size compared to a range of sensors installed in a broad area. Examples of the individual object may be a tank, a wild animal, a vehicle, and a soldier.

Another type is a continuous object tracking for tracking moving objects that disperse in a broad range of a sensor network. Examples of continuous objects may be a toxic gas, wildfire, and biochemical material. The continuous object has a characteristic that the mobility of the continuous object is constantly changing according to the environment and condition of a region where the continuous object is generated. Since the mobility of the continuous object has a characteristic of dispersion, tracking the dispersing shape of the continuous objects becomes an important issue.

In the conventional technology, data of all of the sensor nodes that sense continuous objects are transmitted to a data collection server for determination. However, the sensor node of the wireless sensor network has the characteristics of a significantly small-sized device, having a restricted condition on supplying power, and operating on a limited battery.

Therefore, in order to satisfy the restricted condition of the wireless sensor network, the tracking of the mobility of continuous objects and the transmitting of the data to the data collection server need to be achieved using a minimum number of nodes. With such a demand, numerous studies have been conducted to enhance the efficiency in battery consumption of the sensor node. In addition, there is a need to ensure the reliability that may be threatened from decreasing the number of sensor nodes that transmit data.

A relevant technology is disclosed in Korean Patent Application No. 10-0775504 (Nov. 5, 2007).

### SUMMARY

The following description relates to a method for tracking a boundary of continuous objects, capable of ensuring the reliability by additionally selecting an assistance node.

In one general aspect, a method for tracking a boundary of continuous objects may include selecting representative nodes each representing sensor nodes in a plurality of predetermined areas into which one or more sensor nodes that sense a continuous object event are divided, and receiving boundary information, including event sensing information from the representative nodes that collect the boundary information from the sensor nodes in the respective predetermined areas; selecting one or more assistance nodes configured to collect representative node information from the selected representative nodes, and receiving the representative node information from the assistance nodes that collect the representative node information from the representative nodes; and implementing operation implementing a boundary of continuous objects by combining the boundary information or the representative node information that is received from the respective representative nodes and the respective assistance nodes.

The selecting of the representative nodes in the plurality of predetermined areas may include grouping the one or more sensor nodes into one or more clusters, and selecting one of the sensor nodes in the respective clusters as a representative node.

The selecting of the representative nodes in the plurality of predetermined areas may include, after event sensing information is transmitted and received between sensor nodes, selecting a sensor node that most equally receives event sensing information and event no-sensing information within the predetermined area as the representative node.

The selecting of the representative nodes in the plurality of predetermined areas may include transmitting, at sensor nodes whose event sensing statuses are changed, event sensing information, and selecting a sensor node that has received the largest number of event sensing information that is different from its own event sensing status of the sensor node in the predetermined area as the representative node.

The receiving of the boundary information may include receiving boundary information that includes identification information, position information, and event sensing information of the representative node and remaining sensor nodes in the respective predetermined area.

The selecting of one or more assistance nodes may include transmitting representative node declaration messages to sensor nodes in the respective predetermined areas at the selected respective representative nodes, and selecting, among sensor nodes having received representative node declaration messages from two or more representative nodes, a sensor node which does not receive an assistance node declaration message from a nearby sensor node as an assistance node.

The collecting of the representative node information at the selected assistance nodes comprises transmitting the representative node information to two or more assistance nodes in the predetermined area at a single representative node.

The receiving of the representative node information may comprise collecting representative node information including representative node identification information and representative node position information from two or more representative nodes at the assistance node, and receiving the collected representative node information from the assistance node.

The implementing of the boundary of continuous objects may include implementing the boundary of the continuous objects in a closed loop shape by combining the boundary information each received from the representative nodes.

The implementing of the boundary of continuous objects may include, if the boundary of the continuous objects is not implemented in a closed loop shape due to loss of the boundary information each received from the representative nodes, implementing the boundary of the continuous objects in a closed loop shape by making use of the representative node information received from the assistance nodes.

The implementing of the boundary of the continuous objects may include implementing the continuous object boundary in a closed loop shape by using only the representative node information received from assistance nodes that collect the representative node information.

In another general aspect, a sensor node used in a method for tracking a boundary of continuous objects may include a sensor, a communication module, and a controller. The sensor may sense a continuous object event by sensing environmental information. The communication module may transmit and receive data to and from another sensor node on a wireless sensor network. The controller may control the sensor to sense the continuous object event, and control the communication module to transmit and receive data depending on a status of the sensor node.

The sensor may be at least one sensor to sense environmental information to sense the continuous object event.

The sensor may compare a value of the sensed environmental information with a preset threshold value to sense whether the event occurs.

The communication module may transmit and receive data between the sensor node and a server.

The controller may generate boundary information that includes event sensing information sensed by the sensor and identification information and position information of the sensor node.

The controller, if the sensor node is selected as a representative node, may generate a representative node declaration message, boundary information, or representative node information according to a predetermined representative node selecting method, and control the communication module to transmit the generated representative node declaration message, boundary information, or representative node information to the outside.

The controller, if the sensor node is selected as an assistance node, may generate an assistance node declaration message according to a predetermined assistance node selecting method, and control the communication module to transmit the generated assistance node declaration message or representative node information that is received from a representative node to the outside.

Other features and aspects will be apparent from the following detailed description, the drawings, and the claims.

### BRIEF DESCRIPTION OF THE DRAWINGS

FIG. 1 is a flowchart showing a method for tracking a boundary of continuous objects in accordance with an exemplary embodiment of the present disclosure.

FIG. 2 is a drawing illustrating the selecting of a representative node in a cluster designation scheme in accordance with an exemplary embodiment of the present disclosure.

FIG. 3 is a drawing illustrating the selecting of a representative node in accordance with an exemplary embodiment of the present disclosure.

FIG. 4 is a drawing illustrating the selecting of a representative node in accordance with another exemplary embodiment of the present disclosure.

FIG. 5 is a drawing illustrating a concept of using an assistance node in a method for tracking a boundary of continuous objects in accordance with an exemplary embodiment of the present disclosure.

FIG. 6 is a drawing illustrating the selecting of an assistance node in accordance with an exemplary embodiment of the present disclosure.

FIG. 7 is a block diagram illustrating a sensor node in accordance with an exemplary embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness. In addition, terms described below are terms defined in consideration of functions in the present invention and may be changed according to the intention of a user or an operator or conventional practice. Therefore, the definitions must be based on content throughout this disclosure.

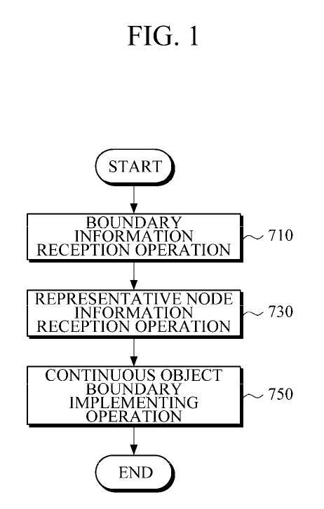

FIG. 1 is a flowchart showing a method for tracking a boundary of continuous objects in accordance with an exemplary embodiment of the present disclosure.

According to a method for tracking a boundary of continuous objects, first, a boundary information reception operation in 710 is performed by dividing one or more sensor nodes to sense a continuous object event, according to a plurality of predetermined areas, to select representative nodes, each representing sensor nodes in the respective predetermined areas, and by receiving boundary information including event sensing information from the representative nodes that collect the boundary information from the sensor nodes in the respective predetermined areas. Then, a representative node information reception operation in 730 is performed by selecting one or more assistance nodes to collect representative node information from the selected representative nodes, and receiving the representative node information from the assistance nodes that receive the representative node information from the representative nodes. Finally, a continuous object boundary implementing operation in 750 is performed by implementing a boundary of continuous objects by combining the boundary information or the representative node information received from the respective representative nodes and the respective assistance nodes.

In the boundary information reception operation in 710, first, an event is sensed by one or more sensor nodes. For the method for tracking the boundary of the continuous objects, multiple sensor nodes each having a sensor function and a wireless communication function may be connected to one another through a wireless sensor network. The wireless sensor network may be composed of multiple sensor nodes for sensing an event, and a server that implements a boundary of continuous objects by collecting data from a sensor.

The sensor node may sense occurrence of an event by collecting the change in environmental information. The environmental information is not limited as long as it is sensed by a sensor, for example, temperature, pressure, humidity, and luminance. In accordance with an exemplary embodiment of the present disclosure, an occurrence of an event may be determined when a value exceeding a threshold value that is predetermined for each environmental information is detected by the sensor node. The event, which is a subject to be sensed, represents an occurrence of continuous objects that move over a relatively broad area, for example, a toxic gas, wildfire, and biochemical material, but is not limited to a specific object.

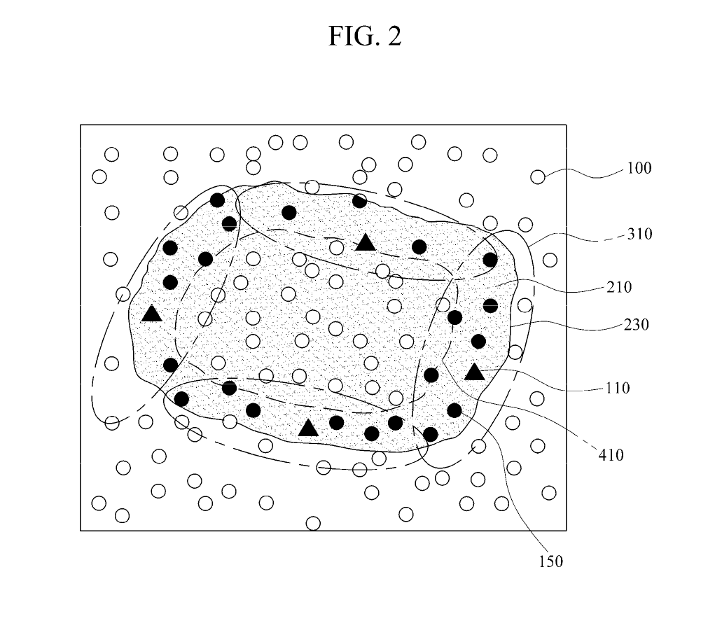

In order to select a representative node, sensor nodes are divided according to a plurality of predetermined areas, and a representative node that may represent remaining sensor nodes in the respective predetermined area is selected. The predetermine area may vary depending on a method for selecting a representative node. In order to select a representative node, sensor nodes may transmit and receive boundary information, which includes identification information, position information, and event sensing information of the sensor nodes in an area in which data transmission/reception between the sensor nodes is possible. A detailed method for selecting a representative node will be described later with reference to FIGS. 2 to 4.

After the representative node is selected, the representative node selected within the respective predetermined area collects the boundary information, including the event sensing information from the sensor nodes within the predetermined area, and transmits the boundary information to the server. The boundary information may include the identification information, the position information, and the event sensing information of the sensor nodes. Instead of transmitting information from all of the sensor nodes that sense an event to the server, only the representative nodes may transmit the boundary information, thereby efficiently implementing a boundary of the continuous objects.

The selected representative node may collect the boundary information, which includes the identification information, position information, and event sensing information from the remaining sensor nodes. The event sensing information is information that indicates whether a corresponding sensor node senses occurrence of continuous objects that are subjects of sensing, and may include event sensing information and event no-sensing information. Through the boundary information, it is determined whether a boundary of continuous objects exists within a certain area.

For example, if a certain representative node receives event sensing information from all of nearby sensor nodes within a certain area, it is determined that a boundary of continuous objects does not exist within the corresponding area. Similarly, if a certain representative node receives event no-sensing information from all of nearby sensor nodes within a certain area, it is determined that a boundary of continuous objects does not exist within the corresponding area.

However, if a certain representative node receives event sensing information from some of nearby sensor nodes within a certain area and receives event no-sensing information from remaining nearby sensor nodes, it is considered that a boundary of continuous objects exists within the corresponding area. In this case, the server may obtain information about the boundary of the continuous objects by analyzing the identification information, position information, and event sensing information of the sensor nodes.

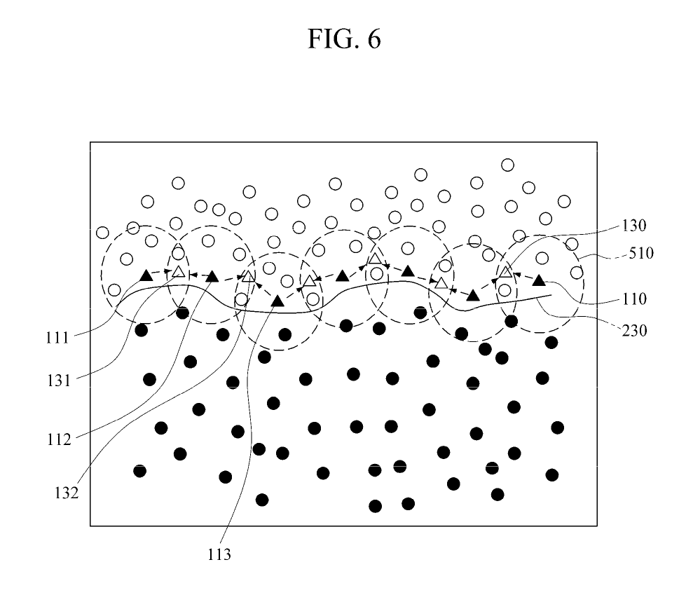

In the representative node information reception operation in 730, one or more assistance nodes may be selected to collect representative node information from the selected representative nodes. Some of the sensor nodes within a predetermined area represented by the representative node may be selected as assistance nodes. The assistance node may collect representative node information that includes the identification information and position information of the representative node from the representative node. A detailed method for selecting assistance nodes will be described later with reference to FIG. 6.

The selected assistance nodes collect representative node information from the representative nodes, and transmit the collected representative node information to the server. The representative node information may include identification information and position information of the representative node. By additionally selecting the assistance node configured to collect representative node information and transmit the collected representative node information to the server, additional boundary data is secured in preparation for the loss of representative node information. In this manner, the server may implement a boundary of continuous objects without delivering a retransmission message when information of a representative node is erroneously transmitted or lost.

In accordance with another exemplary embodiment of the present disclosure, since representative node information that is secured by the assistance nodes is transmitted to prevent the representative nodes from transmitting boundary information to the server, a boundary of continuous object is implemented with enhanced energy efficiency. In this case, the representative node information may further include boundary information that is collected by the representative node. The server may implement a boundary of continuous objects by using only the representative node information received from the assistance nodes.

In the continuous object boundary implementing operation in 750, a boundary of continuous objects is implemented by the server by combining the boundary information or the representative node information received from the respective representative nodes and the respective assistance nodes. The server may identify sensor nodes within a predetermined area that is represented by a corresponding representative node through the boundary information received from each representative node, and recognize the positions of the sensor nodes. A boundary may be implemented between a node that senses an event and a node that does not sense an event depending on whether each sensor node senses an event. By use of boundary information of all of the representative nodes, the overall boundary of continuous objects is implemented.

If a flaw, such as a loss of boundary information received from the representative nodes, occurs, the overall boundary of continuous objects may not be implemented. In this case, the server may finish implementing the boundary of continuous objects using the representative node information received from each assistance node. By use of the representative node information corresponding to additional information received from the assistance node, a representative node having a loss of information is identified, and the position of the representative node having a loss of information is recognized, to restore an area that is not implemented.

In addition, since the representative node does not transmit boundary information to the server, and the assistance node transmits representative node information collected from the representative node to the server, energy and communication expenses can be saved. In this case, in accordance with an exemplary embodiment of the present disclosure, the representative node information may include boundary information received by the representative node in the corresponding predetermined area in addition to information of the representative node.

FIG. 2 is a drawing illustrating the selecting of a representative node in a cluster designation scheme in accordance with an exemplary embodiment of the present disclosure.

In accordance with an aspect of the present disclosure, in selecting the representative node in the boundary information reception operation in 710 of the method for tracking a boundary of continuous objects, sensor nodes 100 are grouped into one or more clusters 310, and one of the sensor nodes 100 forming each cluster 310 is selected as a representative node 110. Referring to FIG. 2, in order to track a boundary 230 of continuous objects 210, sensor nodes within a predetermined area are grouped in a single cluster 310, and a representative node 110 in the cluster 310 may be selected. In this method, the predetermined area represented by the representative node 110 may be an area of the cluster 310.

The respective sensor nodes 100 may exchange data with nearby sensor nodes within a range in which transmission/reception is possible among one another. In accordance with an exemplary embodiment, sensors, among sensors that sensed an event, which receive event no-sensing information from a nearby sensor node, are selected as boundary nodes 150. In accordance with an exemplary embodiment of the present disclosure, one of the boundary nodes 150 in the cluster 310 may be selected as the representative node 110. In this case, in order to reduce an information transmission distance of the sensor node, a boundary node located adjacent to the center of the cluster 310 may be selected as the representative node 110.

The selected representative node 110 receives boundary information, which includes identification information, position information, and event sensing information of the sensor nodes within the cluster 310, and transmits the received boundary information to the server. In this case, the server receives and collects the boundary information from the representative nodes 110 to implement the overall boundary of continuous objects based on the positions and the event sensing results of the sensor nodes.

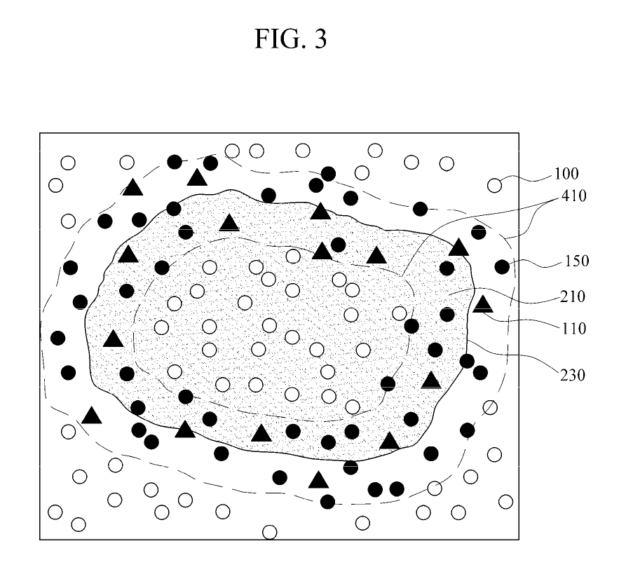

FIG. 3 is a drawing illustrating the selecting of a representative node in accordance with an exemplary embodiment of the present disclosure.

In accordance with an exemplary embodiment of the present disclosure, the selection of the representative node in the boundary information reception operation in 710 of the method for tracking a boundary of continuous objects may include transmitting and receiving event sensing information between sensor nodes, and then selecting a sensor node 100 that most equally receives event sensing information and event no-sensing information within the predetermined area as the representative node 110. In order to track the boundary 230 of the continuous objects 210, the respective sensor nodes 100 may transmit and receive event sensing information to and from the nearby sensor nodes 100 existing within a predetermined area. In accordance with an exemplary embodiment of the present disclosure, the nearby sensor node may be a sensor node existing in a range in which transmission/reception between sensor nodes is possible. In accordance with an exemplary embodiment of the present disclosure, the nearby sensor node may be a sensor node existing within a range of one hop.

In accordance with an exemplary embodiment of the present disclosure, a sensor node, among sensor nodes, which has received event sensing information different from its own event sensing information of the sensor node from the nearby sensor node 100, may be selected as the boundary node 150. In an example in which a sensor node has sensed an event, the sensor node may become a boundary node 150 if the sensor node receives event no-sensing information from a sensor node that has not sensed an event outside of the boundary. Conversely, in a case in which a sensor node has not sensed an event, the sensor node may become a boundary node 150 if the sensor node receives event sensing information from a sensor node that has sensed an event within the boundary. In accordance with an exemplary embodiment of the present disclosure, a boundary node selectable range 410 may be determined depending on the allowable range for transmission/reception between sensor nodes or depending on a range of one hop.

In accordance with an exemplary embodiment of the present disclosure, the event sensing information may be represented as 0 or 1. When the event sensing information is represented as 1, the event no-sensing information may be represented as 0. One sensor node receives the event sensing information, represented as 0 or 1 from nearby sensor nodes, to form an arrangement of event sensing results. In this case, the number of nearby sensor nodes from which the event sensing information is to be received and the sequence in which the arrangement of event sensing results is disposed may be previously determined. Through such, the boundary information may be generated using less data.

A sensor node, among the boundary nodes 150, which has the number of event sensing most equally distributed, may be selected as the representative node 110. For example, when previously assuming that event sensing information is to be received from nearby six sensor nodes, a case in which three results of 0 and three results of 1 are received may be referred to as having the number of event sensing most equally distributed. The selected representative node 110 may receive boundary information of the nearby boundary nodes 150, and transmit the received boundary information to the server. In this case, the server receives and collects the boundary information from the representative nodes 110, and implements an overall boundary of continuous objects based on the positions and the event sensing results of the sensor nodes.

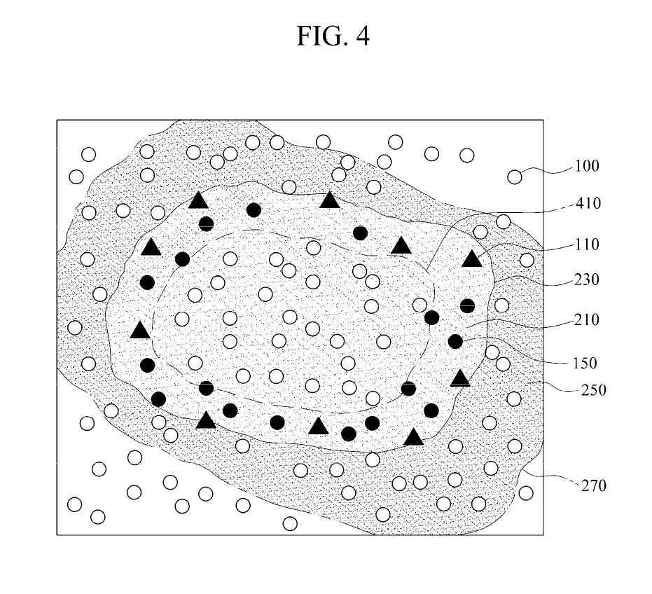

FIG. 4 is a drawing illustrating the selection of a representative node in accordance with another exemplary embodiment of the present disclosure.

In accordance with an aspect of the present disclosure, the selection of the representative node of the boundary information reception operation in 710 includes transmission by sensor nodes whose event sensing statuses are changed, event sensing information, and selection of a sensor node that has received the largest number of event sensing information that is different from its own event sensing status of the sensor node in the predetermined area as the representative node.

In order to track the boundary 230 of the continuous objects 210, the respective sensor node 100 may exchange event sensing information with the nearby sensor node 100 within its own allowable range for transmission/reception between sensor nodes. In accordance with an exemplary embodiment of the present disclosure, the nearby sensor node may be a sensor node existing in a range in which transmission/reception between sensor nodes is possible. In accordance with an exemplary embodiment of the present disclosure, the nearby sensor node may be a sensor node existing within a range of one hop.

In accordance with an exemplary embodiment of the present disclosure, the sensor node 100 may transmit event sensing information to the nearby sensor node 100 when its own event sensing status of the sensor node 100 is changed. FIG. 4 illustrates a case in which the boundary is changed from 270 to 230 due to reduction of the area of the continuous objects. In this case, the sensor nodes existing in an area 250 in which the event sensing status is changed may transmit event no-sensing information to the nearby sensor node.

In accordance with an exemplary embodiment of the present disclosure, a sensor node that has received event sensing information that is different from its own event sensing status of the sensor node is selected as the boundary node 150. Referring to FIG. 4, with the reduction of the area, sensor nodes existing between the reduced boundary 230 and the boundary node selectable range 410 are in a state of the event sensing status, and may become the boundary nodes 150 by receiving event no-sensing information from the sensor nodes that exist in the area 250 in which the event sensing status is changed due to the area reduction.

Different from FIG. 4, if the area of the continuous objects continuously expands, sensor nodes near the outside of the expanded boundary may become a boundary node. The event sensing statuses of sensor nodes within the expanding area are changed from a non-sensing status to a sensing status, so that the sensor nodes within the expanding area may transmit event sensing information. In this case, the sensor nodes outside of the expanded boundary receives event sensing information while in the event no-sensing status, and thus may be selected as boundary nodes.

One, among the boundary nodes 150, which has received the largest number of event sensing information that is different from its own event sensing status of the boundary node is selected as the representative node 110. Such a selection of the representative node 110 may be achieved using a concept that a boundary node located closer to the boundary may receive a larger number of event sensing information different from its own event sensing status than from sensor nodes located at the opposite side of the boundary since the allowable range for transmission/reception between sensor nodes is limited.

The selected representative node 110 may receive boundary information of the nearby boundary nodes 150, and transmit the received boundary information to the server. In this case, the server receives and collects the boundary information from the representative nodes 110 to implement the overall boundary of continuous objects based on the positions and the event sensing results of the sensor nodes.

The above description has been made in relation to three types of selecting a representative node in the method for tracking a boundary of continuous objects, but the present disclosure is not limited thereto. That is, the method for tracking a boundary of continuous objects may be applied to a case selecting a representative node differently from the above described representative node selecting.

In accordance with an exemplary embodiment of the present disclosure, the boundary information reception operation in 710 may include receiving boundary information that includes identification information, position information, and event sensing information of the representative node and remaining sensor nodes within the respective predetermined area. The server may implement a boundary by collecting identification information to identify a sensor node, position information to determine the position of the identified sensor node, and information indicating whether the corresponding sensor node has sensed an event.

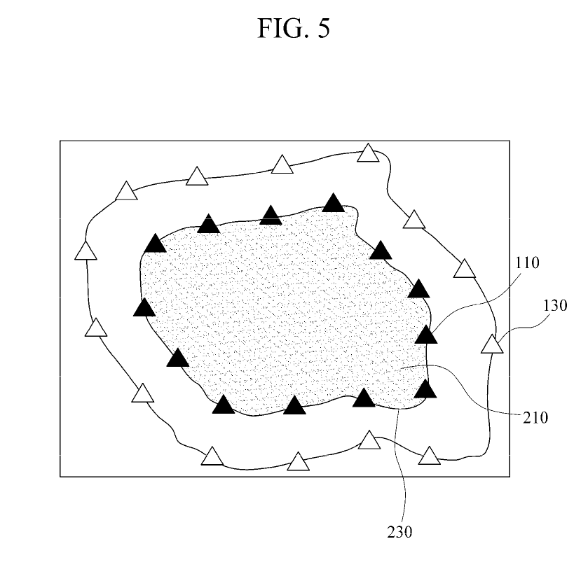

FIG. 5 is a drawing illustrating a concept of using an assistance node in a method for tracking a boundary of continuous objects in accordance with an exemplary embodiment of the present disclosure.

Referring to FIG. 5, in order to track the boundary 230 of the area 210 of the distributed continuous objects that represents an area in which an event occurs, assistance nodes 130 that receive information regarding the representative node 110 from the representative node 110 may be selected in addition to the representative nodes 110. By additionally selecting the assistance node 130 that supports the boundary 230 implemented based on the boundary information transmitted from the representative node 110, boundary information may be obtained even when the representative node 110 does not exist in a portion of the area according to natural environment, such as a river.

After the assistance node 130 that supports the representative node 110 is additionally selected, the assistance node 130 may receive representative node information from two or more representative nodes 110. Even when boundary information of a certain representative node 110 is lost, representative node information is transmitted from the assistance node 130, having received the representative node information of the corresponding representative node 110, to the server, so that the server may implement the boundary of continuous objects in real time without a retransmission algorithm.

In addition, the representative node 110 does not transmit boundary information to the server, but the assistance node 130 transmits representative node information collected from the two or more representative nodes 110, thereby saving the energy and communication expenses of the sensor nodes. In this case, in accordance with an exemplary embodiment of the present disclosure, the representative node information may include boundary information received by the representative node in the corresponding predetermined area, in addition to information of the representative node.

FIG. 6 is a drawing illustrating the selecting of an assistance node in accordance with an exemplary embodiment of the present disclosure.

In accordance with an exemplary embodiment of the present disclosure, the selection of the assistance node in the representative node information reception operation in 730, includes transmitting, by the selected respective representative nodes, representative node declaration messages to sensor nodes in the predetermined area, and selecting one, among sensor nodes that have received the representative node declaration messages from two or more representative nodes, which does not receive an assistance node declaration message from a nearby sensor node as an assistance node.

FIG. 6 is illustrated in relation to the case in which the area of the continuous objects is expanded as shown in FIG. 4 in the method for selecting a representative node in accordance with an exemplary embodiment. If, for instance, the representative node 110 is selected in accordance with an exemplary embodiment of the present disclosure, the representative node 110 may transmit a representative node declaration message indicating the selection as a representative node to nearby sensor nodes within a predetermined area. In accordance with an exemplary embodiment of the present disclosure, the predetermined area may correspond to a range 510 in which transmission/reception is possible between sensor nodes.

In accordance with an exemplary embodiment of the present disclosure, the nearby sensor nodes that have received two representative node declaration messages may become candidates for the assistance node. An assistance node candidate, among a plurality of assistance node candidates, which has not received a message declaring an assistance node from nearby sensor nodes, may be selected as an assistance node 130 by transmitting an assistance node declaration message to nearby sensor nodes existing in a communication range. By canceling an assistance node candidate that has received an assistance node declaration message from the assistance node candidates, among the nodes that have received two representative node declaration messages, one may be selected as an assistance node 130.

The assistance node 130 having received two representative node declaration messages may transmit two pieces of representative node information, that is, identification information and position information of the two representative nodes to the server. In this manner, the server may secure additional data in preparation for loss of boundary information of the representative node 110 in the method for tracking a boundary of continuous objects.

In addition, in accordance with an exemplary embodiment of the present disclosure, the assistance node 130 transmits the collected boundary information to the server on behalf of the representative node 110, thereby saving the energy and communication expense of the sensor nodes.

In accordance with an exemplary embodiment of the present disclosure, the representative node information reception operation in 730 may further include transmission, by a single representative node, of representative node information to two or more assistance nodes in the predetermined region when the selected assistance node collects the representative node information. FIG. 6 illustrate a case in which a single representative node 110 transmits the representative node information to two assistance nodes 130, but the present disclosure is not limited thereto, and depending on the method for selecting the representative node 110 or depending on a need, a single representative node 110 may transmit the representative node information to two or more assistance nodes 130.

In accordance with an exemplary embodiment of the present disclosure, the representative node information reception operation in 730 may further include collecting, by the assistance node 130, representative node information including identification information and position information of a representative node from two or more representative nodes 110, and receiving, by the server, the collected representative node information from the assistance node 130. The server may implement a boundary of continuous objects in case of loss of boundary information of the representative node 110 by collecting identification information to identify a representative node and position information to determine the position of the identified representative node.

In accordance with an exemplary embodiment of the present disclosure, a continuous object boundary implementing operation in 750 may include implementing the boundary of the continuous objects in a closed loop shape by combining the boundary information each received from the representative nodes 110. When implementing a boundary of continuous objects by use of the boundary information, the server may connect boundaries for each predetermined area to each other. In this manner, the overall distribution of continuous objects is recognized.

In accordance with an exemplary embodiment of the present disclosure, the continuous object boundary implementing operation in 750 may include implementing the boundary of the continuous objects in a closed loop shape by use of representative node information received from the assistance nodes 130 if the boundary of the continuous objects is not implemented in a closed loop shape due to loss of boundary information each received from the representative nodes 110. If, for instance, some representative nodes have damages or errors in data transmission, portions of the boundary represented by some representative nodes are not implemented. In this case, the server may implement the boundary using information about the representative node that is included in the additionally received representative node information. In this case, in accordance with an exemplary embodiment of the present disclosure, the representative node information may include boundary information received by the representative node in addition to the identification information and position information of the representative node 110.

In accordance with an exemplary embodiment of the present disclosure, the continuous object boundary implementing operation in 750 may include implementing the boundary of the continuous objects in a closed loop shape by using only the representative node information received from the assistance nodes 130. In this case, in accordance with an exemplary embodiment of the present disclosure, the representative node information may include boundary information received by the representative node in addition to the identification information and position information of the representative node 110. The representative node does not transmit boundary information to the server, but the assistance node transmits the collected representative node information to the server, to implement the boundary of the continuous objects. Consequently, energy consumption and communication expense required for the representative nodes to transmit boundary information to the server are saved.

Hereinafter, the method for tracking a boundary of continuous objects by selecting the assistance node 130 and obtaining representative node information in accordance with an exemplary embodiment of the present disclosure will be described in detail with reference to FIG. 6.

In accordance with an exemplary embodiment of the present disclosure, the representative node information received by the assistance node 130 may include two pieces of representative node information of two representative nodes 110 that are adjacent to the assistant node 130. For the purpose of explanation, when numbering the representative nodes 110 and the assistance nodes 130 starting from the left side of FIG. 6, a first assistance node 131 may receive representative node information of each of a first representative node 111 and a second representative node 112. Similarly, a second assistance node 132 may receive representative node information of each of the second representative node 112 and a third representative node 113. That is, the representative node information received by an n-th assistance node may be representative node information of an n-th representative node and representative node information of an (n+1)-th representative node.

The assistance node 130 may receive representative node information that is duplicated between adjacent representative nodes 110, and transmit the duplicated representative node information to the server. In such as case, when a loss occurs during transmission of boundary information, the lost information is recovered in real time without using a retransmission algorithm for recovery. In addition, even when boundary information of the representative node is not received by the server due to an erroneous operation of the representative node 110, the boundary information may be recovered using the redundant representative node information transmitted from the assistance node 130 without a retransmission process. That is, upon a loss of boundary information at the n-th representative node, the boundary information may be recovered using representative node information of the n-th assistance node or representative node information of the (n−1)-th assistance node.

Since two pieces of duplicated representative node information of adjacent representative nodes 110 are collected and transmitted, even when information loss occurs in the successive representative nodes 110 and the assistance node 130, boundary information may be recovered using representative node information transmitted from another assistance node 130. That is, when information loss occurs in two successive representative nodes 110, that is, an n-th representative node and an (n+)1-th representative node and an (n−1)-th assistance node 130 adjacent to the n-th representative node, the lost information may be recovered using representative node information of the n-th representative node and representative node information of the (n+1)-th representative node that are transmitted from the n-th assistance node. Even when information loss occurs in two successive representative nodes, that is, an n-th representative node and an (n+1)-th representative node and an n-th assistance node 130 adjacent to the n-th representative node and the (n+1)-th representative node, the lost information may be recovered using representative node information of the n-th representative node transmitted from the (n−1)-th assistant node and representative node information of the (n+1)-th representative node transmitted from the (n+1)-th assistance node without a retransmission process.

In accordance with another exemplary embodiment of the present disclosure, the representative nodes 110 do not transmit boundary information to the server, but the assistance node 130 collects two or more duplicated representative node information of the nearby representative nodes 110, and transmits the representative node information to the server on behalf of the representative node 110, thereby saving energy and communication expense.

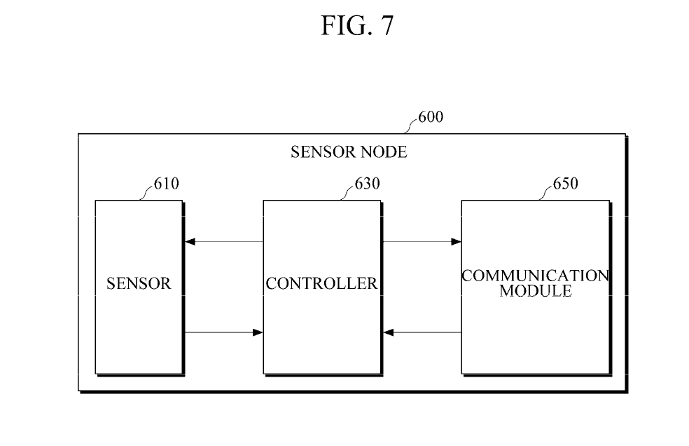

FIG. 7 is a block diagram illustrating a sensor node in accordance with an exemplary embodiment of the present disclosure.

A sensor node 600 used in the method for tracking a boundary of continuous objects includes a sensor 610 configured to sense a continuous object event by sensing environmental information, a communication module 650 configured to transmit and receive data to and from another sensor node on a wireless sensor network, and a controller 630 configured to control the sensor 610 to sense the continuous object event while controlling the communication module 650 to transmit and receive data depending on a status of the sensor node 600.

The sensor 610 may sense a continuous object event by sensing environmental information. The environmental information is not limited as long as it is sensed by a sensor, for example, temperature, pressure, humidity, and luminance. In accordance with an exemplary embodiment, an occurrence of an event may be determined when a value exceeding a threshold value that is predetermined for each environmental information is detected by the sensor node. The event, which is an object to be sensed, represents an occurrence of continuous objects that move over a relatively broad area, for example, a toxic gas, wildfire, and biochemical material, but is not limited to a specific object.

The communication module 650 may transmit and receive data to and from another sensor node on a wireless sensor network. The wireless sensor network may represent a network that may perform data transmission/reception between sensor nodes disposed in a certain region to sense a continuous object event, and transmit the sensed information to a server, but is not limited to a specific method. In accordance with an exemplary embodiment of the present disclosure, the wireless sensor network may include a sink node that collects information from the sensor node and transmits the information to an external server. In accordance with an exemplary embodiment of the present disclosure, the communication module 650 may be a RF (Radio Frequency) communication device configured for communication with a nearby sensor in a multi hop wireless network.

The controller 630 may control the sensor 610 to sense a continuous object event, and may control the communication module 650 to transmit and receive data depending on the status of the sensor node. The status of the sensor node 600 represents a status of the sensor node 600 depending on whether the sensor node 600 has sensed an event or depending on whether the sensor node 600 has been selected as a boundary node, a representative node, or an assistance node. The controller 630 may process the event sensing information, identification information, and position information that correspond to the status of the sensor node, according to a predetermined representative node selecting method or a predetermined assistance node selecting method.

In accordance with an exemplary embodiment of the present disclosure, the sensor 610 may include at least one sensor to sense environmental information to sense the continuous object event. The environmental information is not limited as long as it is sensed by a sensor, for example, temperature, pressure, humidity, and luminance. The sensor is not limited and may be a generally known sensor as long as it can sense the temperature, pressure, and humidity, for example.

In accordance with an exemplary embodiment, the sensor 610 compares a value of the sensed environmental information with a preset threshold value, to sense whether an event occurs. A threshold value is previously set for certain environmental information, and if a value sensed by the sensor 610 in practice is greater than or equal to the threshold value, an occurrence of an event is determined. Alternatively, if a value sensed by the sensor 610 in practice is less than or equal to the threshold value, an occurrence of an event is determined. For example, in case of wildfire, if a temperature sensor senses a temperature greater than or equal to a threshold value, the sensor node may generate and transmit event sensing information indicating that a wildfire has erupted.

In accordance with an exemplary embodiment of the present disclosure, the communication module 650 may transmit and receive data between the sensor node 600 and a server. In addition to a communication device between sensor nodes on a wireless sensor network, a generally known wireless communication device may be further provided to directly exchange data with a server on an external network. In this case, boundary information or representative node information may be directly transmitted to a server without passing through a sink node.

In accordance with an exemplary embodiment of the present disclosure, the controller 630 may generate boundary information that includes event sensing information sensed by the sensor 610 and identification information and position information of a corresponding sensor node. The controller 630 may generate the boundary information in a varied format depending on a representative node selecting method. In accordance with an exemplary embodiment of the present disclosure, the controller 630 may generate the boundary information in the form of a packet. In this case, the sensor node 600 may include an additional packet generator (not shown).

In accordance with an exemplary embodiment of the present disclosure, the controller 630, when a corresponding sensor node is selected as a representative node, may generate a representative node declaration message, boundary information, or representative node information according to a predetermined representative node selecting method, and control the communication module 650 to transmit the generated representative node declaration message, boundary information, or representative node information to the outside. According to a predetermined representative node selecting method algorithm, boundary nodes adjacent to a boundary may be selected, and a representative node may be selected among the selected boundary nodes. The predetermined representative node selecting method algorithm is not limited to a specific representative node selecting method as long as it can select a representative node that transmits boundary information to a server (or a sink node) while representing sensor nodes within a predetermined area. If necessary, the predetermined representative node selecting method algorithm may be changed through a server.

The controller 630, when the sensor node 600 is selected as a representative node, may collect and process boundary information received from sensor nodes existing within a predetermined area, and transmit the processed boundary information to the server through the communication module 650. The format of boundary information may be changed depending on a predetermined representative node selecting method algorithm. In addition, when the sensor node 600 is selected as a representative node, the controller 630 may transmit a representative node declaration message notifying nearby sensor nodes within a predetermined area that the sensor node 600 is selected as a representative node. In addition, when an assistance node is selected, representative node information may be transmitted to assistance nodes within a predetermined area.

In accordance with an exemplary embodiment of the present disclosure, the controller 630, when the corresponding sensor node 600 is selected as an assistance node, may generate an assistance node declaration message according to a predetermined assistance node selecting method, and control the communication module 650 to transmit the generated assistance node declaration message or representative node information, which is received from a representative node, to the outside.

The controller 630, if two or more representative node declaration messages are received, may determine the corresponding sensor node 600 as a candidate for an assistance node. Unless an assistance node declaration message is received as declaration of an assistance node from nearby sensor nodes, the controller 630 may generate an assistance node declaration message. The controller 630 may transmit the generated assistance node declaration message to nearby sensor nodes within a communication range through the communication module 650. In this manner, the sensor node 600 may be selected as an assistance node. Upon receiving an assistance node declaring message from nearby sensor nodes, the controller 630 may determine that the sensor node is canceled from the assistance node candidates.

If the sensor node is selected as an assistance node, the sensor node may receive representative node information from two or more representative nodes. The controller 630 may transmit representative node information, including identification information and position of a representative node, to the server through the communication module 650. In this manner, the server may secure additional data in preparation for loss of boundary information of a representative node in the method for tracking a boundary of continuous objects.

According to the above described method for tracking a boundary of continuous objects, an assistance node to support a representative node is additionally selected, thereby providing real time characteristic of data that is required for tracking the mobility of continuous objects.

In addition, the above described method for tracking a boundary of continuous objects can save a communication expense that may occur from recovering lost information in case of information loss.

In addition, a boundary of continuous objects can be implemented by transmitting representative node information that is collected by an assistance node to the server instead of the representative node transmitting boundary information, thereby saving the energy consumption required for the representative nodes to transmit boundary information while saving a communication expense required for the representative nodes to transmit boundary information to a server.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for tracking a boundary of continuous objects, the method comprising:
selecting representative nodes each representing sensor nodes in a plurality of predetermined areas into which one or more sensor nodes that sense a continuous object event are divided, and receiving boundary information including event sensing information from the representative nodes that collect the boundary information from the sensor nodes in the respective predetermined areas;
selecting one or more assistance nodes configured to collect representative node information from the selected representative nodes, and receiving the representative node information from the assistance nodes that collect the representative node information from the representative nodes; and
implementing a boundary of continuous objects by combining the boundary information or the representative node information that is received from the respective representative nodes and the respective assistance nodes.

2. The method of claim 1, wherein the selecting of the representative nodes in the plurality of predetermined areas comprises grouping the one or more sensor nodes into one or more clusters, and selecting one of the sensor nodes in the respective clusters as a representative node.

3. The method of claim 1, wherein the selecting of the representative nodes in the plurality of predetermined areas comprises, after event sensing information is transmitted and received between sensor nodes, selecting a sensor node that most equally receives event sensing information and event no-sensing information within the predetermined area as the representative node.

4. The method of claim 1, wherein the selecting of the representative nodes in the plurality of predetermined areas comprises transmitting, at sensor nodes whose event sensing status are changed, event sensing information, and selecting a sensor node that has received largest number of event sensing information that is different from its own event sensing status of the sensor node in the predetermined area as the representative node.

5. The method of claim 1, wherein the receiving of the boundary information comprises receiving boundary information that includes identification information, position information, and event sensing information of the representative node and remaining sensor nodes in the respective predetermined area.

6. The method of claim 1, wherein the selecting of one or more assistance nodes comprises transmitting representative node declaration messages to sensor nodes in the respective predetermined areas at the selected respective representative nodes, and selecting, among sensor nodes having received representative node declaration messages from two or more representative nodes, a sensor node which does not receive an assistance node declaration message from a nearby sensor node as an assistance node.

7. The method of claim 1, wherein the collecting of the representative node information at the selected assistance nodes comprises transmitting the representative node information to two or more assistance nodes in the predetermined area at a single representative node.

8. The method of claim 1, wherein the receiving of the representative node information comprises collecting representative node information including representative node identification information and representative node position information from two or more representative nodes at the assistance node, and receiving the collected representative node information from the assistance node.

9. The method of claim 1, wherein the implementing of the boundary of continuous objects comprises implementing the boundary of the continuous objects in a closed loop shape by combining each boundary information received from the representative nodes.

10. The method of claim 1, wherein the implementing of the boundary of continuous objects comprises, if the boundary of the continuous objects is not implemented in a closed loop shape due to loss of the boundary information received from the representative nodes, implementing the boundary of the continuous objects in a closed loop shape by making use of the representative node information received from the assistance nodes.

11. The method of claim 1, wherein the implementing of the boundary of the continuous objects comprises implementing the continuous object boundary in a closed loop shape by using only the representative node information received from assistance nodes that collect the representative node information.

12. A sensor node used in a method for tracking a boundary of continuous objects, the sensor node comprising:
a sensor configured to sense a continuous object event by sensing environmental information;
a communication module configured to transmit and receive data to and from another sensor node on a wireless sensor network; and
a controller configured to control the sensor to sense the continuous object event, and control the communication module to transmit and receive data depending on a status of the sensor node.

13. The sensor node of claim 12, wherein the sensor is at least one sensor to sense environmental information to sense the continuous object event.

14. The sensor node of claim 12, wherein the sensor compares a value of the sensed environmental information with a preset threshold value, to sense whether the event occurs.

15. The sensor node of claim 12, wherein the communication module transmits and receives data between the sensor node and a server.

16. The sensor node of claim 12, wherein the controller generates boundary information that includes event sensing information sensed by the sensor and identification information and position information of the sensor node.

17. The sensor node of claim 12, wherein the controller, if the sensor node is selected as a representative node, generates a representative node declaration message, boundary information, or representative node information according to a predetermined representative node selecting method, and controls the communication module to transmit the generated representative node declaration message, boundary information, or representative node information to the outside.

18. The sensor node of claim 12, wherein the controller, if the sensor node is selected as an assistance node, generates an assistance node declaration message according to a predetermined assistance node selecting method, and controls the communication module to transmit the generated assistance node declaration message or representative node information that is received from a representative node to the outside.
